(19) United States
(12) Patent Application Publication
(10) Pub. No.: US 2011/0225593 A1
(43) Pub. Date: Sep. 15, 2011

(54) INTERFACE-BASED ENVIRONMENTALLY SUSTAINABLE COMPUTING

(75) Inventors: Rick A. Hamilton, II, Charlottesville, VA (US); James R. Kozloski, Yorktown Heights, NY (US); Brian M. O'Connell, Research Triangle Park, NC (US); Clifford A. Pickover, Yorktown Heights, NY (US); Keith R. Walker, Austin, TX (US)

(73) Assignee: International Business Machines Corporation, Armonk, NY (US)

(21) Appl. No.: 12/721,715

(22) Filed: Mar. 11, 2010

(51) Int. Cl. G06F 9/46

(52) U.S. Cl. 718/104

(57) ABSTRACT

Implementation of interface-based environmentally sustainable computing is provided. A method includes retrieving usage characteristics of a process scheduled to execute on a computer system and determining an environmental impact of the process on the computer system by mapping the usage characteristics of the process to corresponding environmental costs of the usage characteristics. The method also includes implementing an action on the computer system in response to the environmental impact. The actions are pre-configured for administration based upon a threshold level of environmental impact associated with the process and/or user selection.

### BACKGROUND

The present invention relates to green computing, and more specifically, to interface-based environmentally sustainable computing.

Environmentally responsible computing (also known as “green IT” or “green computing”) has been defined as the design, manufacture, use, and disposal of information technology (IT)-related devices and services (e.g., computers, servers, and subsystems such as monitors, printers, storage devices, as well as associated network and communications systems) using mechanisms determined to incur the least amount impact on the environment; that is, a reduced or minimized ‘carbon footprint.’ Green IT is also known to focus on finding ways to balance economic viability and efficient system performance with social and ethical responsibilities.

Traditionally, firewalls intervene between a computer system and a network, inspecting, permitting, and/or denying computer traffic between the system and certain designated security domains of the network. Firewalls seek to maintain the integrity of the system, protecting it from attack, malicious network computer traffic, and safeguarding data on the system from unauthorized use or theft. As environmental concerns increase, and as the energy costs associated with computer systems and their environmental impact continue to rise, the relative value of data integrity and environmental impact to a computer system will become comparable.

The operating system of a computer system is responsible for determining how system hardware resources (e.g., CPUs, disks, printers) are allocated to programs and processes that are requesting to run on the system. Typically, this determination is made based on examination of interrupts and system calls from applications and device drivers requesting to use these resources, and a scheduler that determines how much time a particular request requires, and the order of execution control passed to the requesting entities. The principle of this determination is that all requests be satisfied in the most efficient (time minimal) way possible. The scheduler may be aware of system resources and their performance capability, but typically does not maintain a profile of how specific tasks will use these resources. Instead, priorities may be assigned to the various tasks waiting to run, and at some interval, these priorities may be recalculated. Priorities may be wholly a function of some scheduling algorithm (e.g., round robin, first-in-first-out), or may be based on static or dynamic properties of the tasks.

In addition to time, other resources are consumed by tasks scheduled by an operating system, and consumption of these resources has measurable environmental impact. These include physical resources (e.g., paper and ink in a printer) and energy. Neither of these resources is traditionally considered, either statically or dynamically, by a scheduler when scheduling tasks for the operating system. The optimization performed by a scheduler minimizes the time all tasks take to run, in part by consuming as few computational resources itself as possible (i.e., the scheduler algorithm is typically as efficient as possible so as to leave as many resources to the tasks as possible). The problem of assigning environmental impact costs to specific tasks or processes, and adjusting the scheduling and/or status of these processes accordingly are therefore separate from traditional OS and task scheduler functions. The problem is significant, especially as energy and natural resource costs increase, and as computational demands for these resources grow. In addition, individual and institutional users of computational systems may need to configure at a high level the acceptable limits of the system's consumption of these resources and their related environmental impacts in order to maintain compliance with internal or external standards.

A need therefore exists to provide a way to intervene between an operating system scheduler and associated hardware resources of a system to control and minimize the environmental costs associated with processes running on the system.

### SUMMARY

According to one embodiment of the present invention, a method for implementing interface-based environmentally sustainable computing is provided. The method includes retrieving usage characteristics of a process scheduled to execute on a computer system and determining an environmental impact of the process on the computer system by mapping the usage characteristics of the process to corresponding environmental costs of the usage characteristics. The method also includes implementing an action on the computer system in response to the environmental impact. The actions are pre-configured for administration based upon a threshold level of environmental impact associated with the process and/or user selection.

According to another embodiment of the present invention, a computer system for implementing interface-based environmentally sustainable computing is provided. The system includes a computer processor and a control system application executing on the computer processor. The control system application implements a method. The method includes retrieving usage characteristics of a process scheduled to execute on the computer system and determining an environmental impact of the process on the computer system by mapping the usage characteristics of the process to corresponding environmental costs of the usage characteristics. The method also includes implementing an action on the computer system in response to the environmental impact. The actions are pre-configured for administration based upon a threshold level of environmental impact associated with the process and/or user selection.

According to a further embodiment of the present invention, a computer program product for implementing interface-based environmentally sustainable computing is provided. The computer program product includes a computer-readable storage medium having program code embodied thereon. Upon execution by a computer processor, the program code implements a method. The method includes retrieving usage characteristics of a process scheduled to execute on a computer system and determining an environmental impact of the process on the computer system by mapping the usage characteristics of the process to corresponding environmental costs of the usage characteristics. The method also includes implementing an action on the computer system in response to the environmental impact. The actions are pre-configured for administration based upon a threshold level of environmental impact associated with the process and/or user selection.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description, taken in conjunction with the accompanying drawings, in which:

FIG. 1 depicts a block diagram of a system upon which interface-based environmentally sustainable computing may be implemented in an exemplary embodiment; and

FIG. 2 illustrates a flow diagram describing a process for implementing the interface-based environmentally sustainable computing in an exemplary embodiment.

### DETAILED DESCRIPTION

In exemplary embodiments, interfaced-based environmentally sustainable computing is provided. Exemplary methods include monitoring the current or expected environmental impact of processes running on a computer system, recognizing malicious, faulty, or circumstantial over-usage of these resources based on, e.g., heuristics, and restoring the system to some preconfigured level of desired environmental impact when processes have exceeded or are about to exceed these standards.

An exemplary interface-based system via, e.g., a layer of software control, intervenes between process schedulers of an operating system and computer system hardware (as a principle consumer of energy) to determine if by fault, malicious intent, or circumstances, a particular process is driving the system into noncompliance with environmental standards and should therefore be blocked from accessing the hardware.

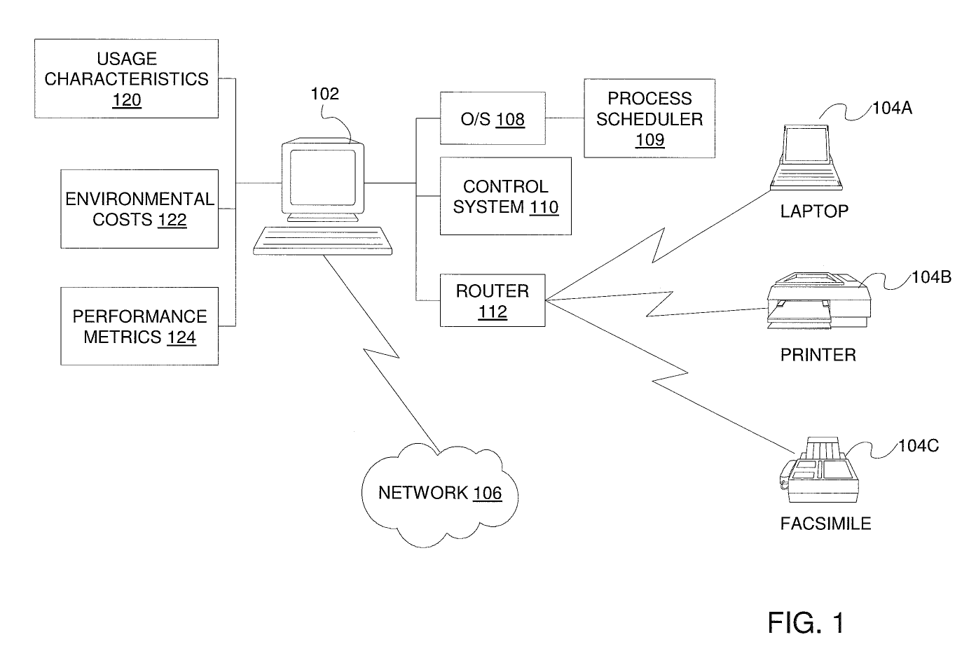

Turning now to FIG. 1, an exemplary interface-based system for providing environmentally sustainable computing will now be described. The system of FIG. 1 includes a computer device 102 in communication with one or more networks 106 and peripheral devices 104A-104C via a router 112. The system configuration exemplified in FIG. 1 illustrates one example of a system that employs the interface-based environmentally sustainable computing methods described herein. It will be understood that variations to the system of FIG. 1 may be made in order to realize the advantages of the exemplary embodiments.

The computer device 102 may be implemented as a general-purpose or personal computer, e.g., desktop computer, laptop, personal digital assistant, etc. The computer device 102 may be configured as part of a local area network (LAN) via the router 112 in order to communicate with other LAN devices (e.g., laptop 104A, printer 104B, and facsimile 104C). Likewise, the computer device 102 may communicate over one or more networks 106 via the router 112. In one exemplary embodiment, the system of FIG. 1 represents a home network. In alternative exemplary embodiments, the system may represent a portion of a larger networked computer system in which a number of computer devices (e.g., 102) communicate with one another as well as peripheral devices 104A-104C over a local area network, wide area network, virtual private network, Internet, or a combination of the above. For ease of illustration, the system described herein with respect to FIG. 1 represents a home network.

Computer device 102 may include hardware and software components typically found, for example, in a general-purpose computer (e.g., input/output elements, operating system (O/S) 108, O/S process scheduler 109, memory, CPUs, and various applications). As shown in FIG. 1, the computer device 102 includes an operating system 108 and process scheduler 109. The process scheduler 109 is shown in FIG. 1 to be an integrated component of the O/S 108.

The computer device 102 may store in its memory, and/or within storage accessible to the computer device 102, one or more databases 120 of various usage characteristics of processes identified for applications and system logic associated with the computer device 102 and/or its peripheral devices 104A-104C. Usage characteristics refer to one or more aspects of a process that are directly related to its function and its relationships with, and/or effect on, elements of the system. Usage characteristics may include, e.g., total memory accesses (allocation/deallocation), local cache utilization, computer processing unit (CPU) clock speed, the cooling requirements of the system (e.g., external chiller power consumption, internal fan speeds, etc.), display characteristics, graphics processing unit (GPU) utilization, network input/output (I/O), flash drive reads and writes, CD/DVD drive utilization, and the presence or absence of specific universal serial bus (USB) peripherals.

The computer device 102 may further store in its memory, and/or within storage accessible to the computer device 102, one or more databases 122 of environmental costs estimated or known to be associated with usage characteristics from database 120. Environmental costs refer to a quantitative impact on the environment caused by, or resulting from, process execution with respect to corresponding usage characteristics. Environmental costs may be determined (or estimated) based upon factors, e.g., the recognition of the specific process attempting to run (such as, malicious code detection), and a pattern of behaviors the process is attempting to engage in (e.g., repeated access to disk without significant modification to the size of the disk's available space). These costs may include power consumption, the production of heat exhaust into the environment, waste water production from water-cooled systems, physical waste from expired system components, sonic noise, paper and ink consumption, and variable costs associated with external suppliers and their constraints (for example a variable cost of power). In addition, certain costs may be negative, for example if a process helps other processes to reduce their environmental costs, these cost savings may accrue to the helper process resulting in a negative cost.

The computer device 102 may further store in its memory, and/or within storage accessible to the computer device 102, one or more databases 124 of performance metrics that specify a threshold level of acceptable impact (e.g., environmental costs) for a given process. Based upon currently monitored processes, the control system 110 may be configured to act on a particular process to maintain existing levels of system performance or to bring the system within some acceptable range of performance based upon the performance metrics. Actions may include, e.g., terminating the process, notifying a user of the computer device (or administrator of the system), automatically adjusting the system to bring it into the acceptable level of performance, and permitting the user, once notified, to take action that would bring the system into acceptable levels of performance. Levels may be set according to a measured quantity (for example, a certain amount of power consumption), some average or integral of this quantity over time (for example energy consumption), a maximum or minimum peak value of this quantity over some time period (for example, peak power consumption), or some other maximum or minimum derivative of this quantity over some time period (for example, a maximum acceptable change in power consumption).

The computer device 102 also includes a control system 110. In an exemplary embodiment, the control system 110 acts as an interface between the O/S 108 scheduler 109 and the hardware/software associated with the computer device 102. The control system 110 monitors the current or expected environmental impact of processes running on a computer system, recognizes malicious, faulty, or circumstantial over-usage of these resources based on, e.g., heuristics, and restores the system to some preconfigured level of desired environmental impact when processes have exceeded or are about to exceed these standards. The monitored processes may be implemented by hardware or peripheral components of the computer device 102 (e.g., CPU processing, storage access in memory, printing, etc). These and other aspects of the control system 110 are described further herein.

While shown as two distinct components in FIG. 1 for purposes of illustration and ease of description, it will be understood that the process scheduler 109 may be integrated with the control system 110 as a single element of the O/S 108 (e.g., built-in to the O/S 108) or may be a separate interface component (e.g., a plug-in) that communicates between the O/S process scheduler 109 and various hardware/software components of the computer system 102.

The O/S 108 is responsible for determining how system hardware resources (e.g., CPUs, disks, printers) are allocated to programs and processes that are requesting to run on the system. This determination is made, in part, based on examination of interrupts and system calls from applications and device drivers requesting to use these resources, and the process scheduler 109 that determines how much time a particular request requires, and the order of execution control passed to the requesting entities. The O/S 108 and process scheduler 109 seek to ensure that various requests are satisfied in the most efficient (time minimal) way possible. The scheduler 109 may be aware of system resources and their performance capability, but typically does not maintain a profile of how specific tasks will use these resources. Instead, priorities may be assigned to the various tasks waiting to run, and at some interval, these priorities may be recalculated. Priorities may be wholly a function of some scheduling algorithm (e.g., round robin, first-in-first-out), or may be based on static or dynamic properties of the tasks.

Peripheral devices 104A-104C may communicate with the computer device 102, e.g., over a LAN via the router 112 in a wired or wireless manner. It will be understood that various other types of peripheral devices may be in communication with the computer device 102 shown in FIG. 1 (via the router 112, direct cabling, or similar means) and that the illustrated devices 104A-104C are shown as non-limiting examples thereof.

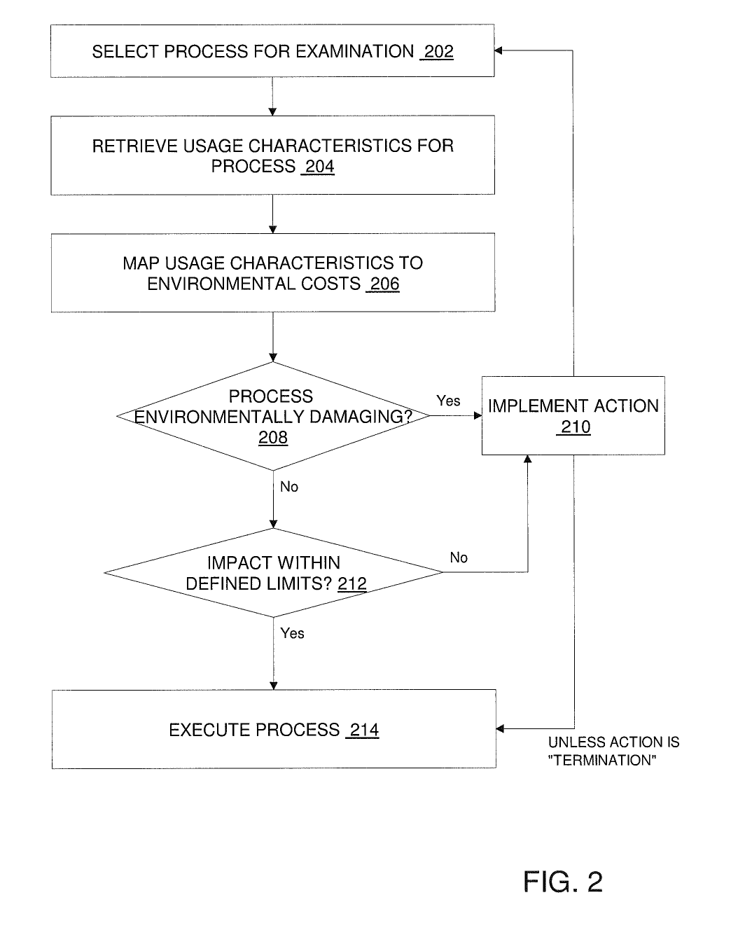

Turning now to FIG. 2, an exemplary process for implementing interface-based environmentally sustainable computing will now be described. In an exemplary embodiment, application processes scheduled by the process scheduler 109 with respect to hardware components of a computer device (e.g., device 102) or peripheral components (e.g., 104A-104C) are examined by the control system 110. In an exemplary embodiment, the control system 110 is pre-configured to implement the actions set forth in the flow diagram of FIG. 2 below.

At step 202, the control system 110 selects a process from the schedule to examine. A process may be an instruction used to access a resource for purposes of executing a task (e.g., read, write, copy, print, etc.).

At step 204, the control system 110 accesses usage characteristics of the process. In one exemplary embodiment, the control system 110 retrieves this information from database 120 of FIG. 1.

At step 206, the control system 110 maps these usage characteristics for the process to corresponding environmental costs associated with the process. In an exemplary embodiment, the control system 110 retrieves the environmental costs information from database 122 of FIG. 1.

At step 208, the control system 110 determines if the process is environmentally damaging to the computer device 102 or devices associated therewith. For example, if the process relates to malicious computer code, the control system 110 maps the process to the corresponding environmental costs, which costs may include partial or total disruption, degradation, or impairment of the system's ability to control overall environmental costs.

If the process is determined to be environmentally damaging to the computer device 102 or related devices, the control system 110 takes one or more actions at step 210 based upon, e.g., how the control system 110 is configured to handle such determinations. For example, if the environmental costs of the process are severe (e.g., significant or total degradation of the system's ability to control overall environmental costs, as defined via the control system 110), the control system 110 may be configured to automatically terminate the process or direct the process scheduler 109 to terminate the process. In addition, the control system 110 may be configured to notify a user of the computer device 102 (or administrator of the system) of the determination. In this instance, the user or administrator may implement the desired action to terminate the process. In addition, the control system 110 may log this determination including the identification of the process and store this information in memory (e.g., computer device 102). The control system 110 then returns to step 202 whereby the next process is selected for examination.

If the process is not environmentally damaging (step 208), the control system 110 determines if the environmental impact of the process falls within acceptable limits as defined by a threshold value at step 212. This determination may be implemented by using the results of step 206 (i.e., mapping usage characteristics to environmental costs) and comparing the result to the performance metrics configured for the system in database 124. An example of such a determination may involve a process (referred to herein as helper process) which has a high rate of disk utilization due to accessing a database but which also includes a function that helps manage and minimize memory accesses of all other processes running on a system. Because memory accesses are known to have a high power consumption cost, the cost savings associated with this helper process' optimization of memory usage may then be used to offset the cost of its estimated database and disk accesses. Once this cost and offset are totaled by the system, their total is then added to another quantity in order to determine if the running of the helper process will result in a violation of some maximum acceptable power consumption of the system. If the performance requirement is not violated, the helper process may be run, and its positive effects on other processes are accrued by the system's overall performance. For example, the control system 110 may be configured to determine how compliance may benefit by terminating a process. In the case of a helper process, although it may heavily access a disk, overall compliance with performance requirements may suffer it if is terminated, as it saves on power consumed by other processes. This is accounted for by the control system 110. For the other processes, the system benefits in a different way when the other processes are terminated (e.g., memory accesses are eliminated and, in addition, the helper process now has free resources to help other processes manage memory). For this reason, the non-optimized cost of memory accesses by the terminated process should be considered (since the benefit of optimization has already accrued to the helper process), and deducted from the quantity. Additional side effects may also include an estimate of whether or not the helper process has other processes it could then optimize. If not, the benefit of terminating a process may be discounted.

If the environmental impact of the process falls within acceptable limits (step 212), the process is allowed to proceed execution on the computer device 102 at step 214, and the control system 110 selects the next scheduled process to examine (step 202).

Otherwise, if the environmental impact is not within acceptable limits at step 212, the control system 110 implements an action at step 210 based upon the result at step 212. For example, control system 110 may be configured to determine and implement an adjustment to the process that, upon execution, would place the system performance inline with the performance metrics identified in the database 124. An example of a possible process that may place the system performance outside of acceptable limits might include downloading a large multimedia file. Another action implemented by the control system 110 may be sending a notification to the user that the process, if implemented, would place the environmental impact outside of the acceptable limits. The user may be given this notification and/or may be permitted to make the decision whether to adjust the process as outlined above. For example, suppose the process is directed to downloading a large multimedia file. If the file is important to the user, the user may override a suggestion by the control system 110 to adjust the process (e.g., a suggestion to modify the file using compression techniques, or delay downloading the file to a later time). Likewise, the user (or, autonomously by the control system 110) may decide to execute the process at a later time when the system is expected or known to be idle, or alternatively, terminate the process entirely. In this manner, the control system 100, either by itself or on behalf of the user is able to re-prioritize scheduled processes based on expected environmental impacts of the process on the system. Another possible action that may be taken by the control system 110 in response to the impact of the process being outside of the acceptable limits is to log the determination in a log file (e.g., in memory of computer device 102). In addition, the control system 110 may be configured to implement a combination of the above actions (e.g., notifying a user and logging the determination in a log file). The control system returns to step 202 and examines the next scheduled process.

The exemplary interface-based environmentally sustainable computing described above enables an interface component (i.e., control system 110) to manage system resources consumed, thereby controlling (minimizing) environmental impact on system performance. In addition, the interface component may be configured to set performance metrics within a specified range, and ensure that the system performs within that range. Environmentally damaging processes may be examined and retuned by software designers based on, e.g., system logs generated by the interface component.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the preferred embodiment to the invention has been described, it will be understood that those skilled in the art, both now and in the future, may make various improvements and enhancements which fall within the scope of the claims that follow. These claims should be construed to maintain the proper protection for the invention first described.

What is claimed is:

1. A method for implementing interface-based environmentally sustainable computing, the method comprising:
retrieving usage characteristics of a process scheduled to execute on a computer system;
determining an environmental impact of the process on the computer system by mapping the usage characteristics of the process to corresponding environmental costs of the usage characteristics; and
implementing an action on the computer system in response to the environmental impact, wherein actions are pre-configured for administration based upon at least one of: a threshold level of environmental impact associated with the process, and user selection.

2. The method of claim 1, wherein the usage characteristics include at least one of:
total memory accesses;
local cache utilization;
computer processing unit clock speed;
cooling metrics of the computer system;
display characteristics of the computer system;
network input/output (I/O);
flash drive reads and writes;
CD/DVD drive utilization;
the presence of specified universal serial bus (USB) peripherals; and
the absence of specified universal serial bus (USB) peripherals.

3. The method of claim 1, wherein the environmental costs include at least one of:
power consumption;
production of heat exhaust into the environment;
waste water production from water-cooled systems;
physical waste from expired system components;
sonic noise;
paper consumption;
ink consumption; and
variable costs associated with external suppliers and related supplier constraints.

4. The method of claim 1, wherein the environmental costs include negative costs associated with implementation of a process that is configured to assist another process, the negative costs comprising costs savings attributed to a reduction in environmental costs that would otherwise be incurred should the other process be implemented without assistance from the process.

5. The method of claim 1, wherein the threshold level of environmental impact is defined by a threshold value or range corresponding to at least one of the usage characteristics.

6. The method of claim 1, wherein the threshold level of environmental impact is defined by a value representing an average or integral of a measure of at least one of the usage characteristics.

7. The method of claim 1, wherein the threshold level of environmental impact is defined by a value representing a peak value of measure of at least one of the usage characteristics.

8. The method of claim 1, wherein the threshold level of environmental impact is defined by a value representing a derivative of a defined measure of at least one of the usage characteristics.

9. The method of claim 1, wherein implementing an action on the computer system in response to the environmental impact includes implementing at least one of:
executing the process;
terminating the process;
determining an adjustment to the process that upon execution brings the computer system into compliance with a defined performance metric; and
logging the environmental impact in a log file.

10. A computer system for implementing interface-based environmentally sustainable computing, comprising:
a computer processor; and
a control system application executing on the computer processor, the control system application implementing a method, the method comprising:
retrieving usage characteristics of a process scheduled to execute on the computer system;
determining an environmental impact of the process on the computer system by mapping the usage characteristics of the process to corresponding environmental costs of the usage characteristics; and
implementing an action on the computer system in response to the environmental impact, wherein actions are pre-configured for administration based upon at least one of: a threshold level of environmental impact associated with the process, and user selection.

11. The computer system of claim 10, wherein the usage characteristics include at least one of:
total memory accesses;
local cache utilization;
computer processing unit clock speed;
cooling metrics of the computer system;
display characteristics of the computer system;
network input/output (I/O);
flash drive reads and writes;
CD/DVD drive utilization;
the presence of specified universal serial bus (USB) peripherals; and
the absence of specified universal serial bus (USB) peripherals.

12. The computer system of claim 10, wherein the environmental costs include at least one of:
power consumption;
production of heat exhaust into the environment;
waste water production from water-cooled systems;
physical waste from expired system components;
sonic noise;
paper consumption;
ink consumption; and
variable costs associated with external suppliers and related supplier constraints.

13. The computer system of claim 10, wherein the environmental costs include negative costs associated with implementation of a process that is configured to assist another process, the negative costs comprising costs savings attributed to a reduction in environmental costs that would otherwise be incurred should the other process be implemented without assistance from the process.

14. The computer system of claim 10, wherein the threshold level of environmental impact is defined by a threshold value or range corresponding to at least one of the usage characteristics.

15. The computer system of claim 10, wherein the threshold level of environmental impact is defined by a value representing an average or integral of a measure of at least one of the usage characteristics.

16. The computer system of claim 10, wherein the threshold level of environmental impact is defined by a value representing a peak value of measure of at least one of the usage characteristics.

17. The computer system of claim 10, wherein the threshold level of environmental impact is defined by a value representing a derivative of a defined measure of at least one of the usage characteristics.

18. A computer program product for implementing interface-based environmentally sustainable computing, the computer program product comprising a computer-readable storage medium having program instructions embodied thereon, which when executed by a computer processor, cause the computer processor to implement a method, the method comprising:
retrieving usage characteristics of a process scheduled to execute on a computer system;
determining an environmental impact of the process on the computer system by mapping the usage characteristics of the process to corresponding environmental costs of the usage characteristics; and
implementing an action on the computer system in response to the environmental impact, wherein actions are pre-configured for administration based upon at least one of: a threshold level of environmental impact associated with the process, and user selection.

19. The computer program product of claim 18, wherein the usage characteristics include at least one of:
total memory accesses;
local cache utilization;
computer processing unit clock speed;
cooling metrics of the computer system;
display characteristics of the computer system;
network input/output (I/O);
flash drive reads and writes;
CD/DVD drive utilization;
the presence of specified universal serial bus (USB) peripherals; and
the absence of specified universal serial bus (USB) peripherals.

20. The computer program product of claim 18, wherein the environmental costs include at least one of:
power consumption;
production of heat exhaust into the environment;
waste water production from water-cooled systems;
physical waste from expired system components;
sonic noise;
paper consumption;
ink consumption; and
variable costs associated with external suppliers and related supplier constraints.

21. The computer program product of claim 18, wherein the environmental costs include negative costs associated with implementation of a process that is configured to assist another process, the negative costs comprising costs savings attributed to a reduction in environmental costs that would otherwise be incurred should the other process be implemented without assistance from the process.

22. The computer program product of claim 18, wherein the threshold level of environmental impact is defined by a threshold value corresponding to at least one of the usage characteristics.

23. The computer program product of claim 18, wherein the threshold level of environmental impact is defined by a value representing an average or integral of a measure of at least one of the usage characteristics.

24. The computer program product of claim 18, wherein the threshold level of environmental impact is defined by a value representing a peak value of measure of at least one of the usage characteristics.

25. The computer program product of claim 18, wherein the threshold level of environmental impact is defined by a value representing a derivative of a defined measure of at least one of the usage characteristics.
